(19) United States
(12) Patent Application Publication
(10) Pub. No.: US 2018/0288681 A1
(43) Pub. Date: Oct. 4, 2018

(54) CELL SELECTION BASED ON CONGESTION LEVELS

(71) Applicant: Telefonaktiebolaget LM Ericsson (publ), Stockholm (SE)

(72) Inventors: Ricardo PAREDES CABRERA, Ottawa (CA); Bing HU Z., Kanata (CA); Jayson CHAN, Kanata (CA)

(73) Assignee: Telefonaktiebolaget LM Ericsson (publ), Stockholm (SE)

(21) Appl. No.: 15/762,071

(22) PCT Filed: Sep. 22, 2015
(86) PCT No.: PCT/IB2015/057313

§ 371 Date: Mar. 21, 2018

(51) Int. Cl. H04W 48/06; H04W 48/10

(52) U.S. Cl. CPC H04W 48/06; H04W 88/06; H04W 48/10

(57) ABSTRACT

A method for wireless communication by a user equipment for selecting a cell from one or more cells based on associated congestion levels is provided. The method comprises acquiring a cell congestion level for each cell from one or more cells of a first radio technology, the first radio technology being an access control radio technology, the cell congestion levels being acquired based on an access control parameters. The method also comprises using the acquired congestion levels to determine whether at least one suitable candidate cell for providing service to the user equipment exists among the one or more cells of the first radio technology. Cell of a second radio technology are considered if a suitable cell based on the first technology is not found. A user equipment, computer program product and computer program for cell selection based on congestion levels is also provided.

### TECHNICAL FIELD

The present disclosure relates to wireless communication and in particular to methods, user equipment, computer programs and computer program products for cell selection based on cell congestion levels.

### BACKGROUND

Various wireless communication systems use a network of base stations to communicate with user equipment registered for services in the systems. Each base station (BS) emits and receives radio frequency (RF) signals that convey data to and from the user equipment (UE).

In certain current radio technologies such as Third Generation Partnership Project (3GPP) Long Term Evolution (LTE), a UE may be able to communicate with one or more bases stations within multiple cells based on the same radio technology. For example, in a high-density cellular environment, the UE may be serviced by a plurality of base stations, each having overlapping cells. In addition, for example, in a carrier aggregation environment, a UE may communicate with a base station via a primary cell and/or via one or more secondary cells. Moreover, in order to expand the services available to subscribers, some UE's support communications with multiple radio technologies. For example, a multi-mode UE may support communication based on LTE, Wideband Code-Division Multiple Access (WCDMA), Worldwide Interoperability for Microwave Access (WiMAX), code division multiple access (CDMA), WiFi etc.

For such UE's, there is a need to determine the most suitable cell available to provide a certain service. In particular, selecting cells based on the congestion level of each cell would be beneficial in improving the bandwidth available to the user equipment.

A need for mechanisms enabling a user equipment to select cells based on congestion levels is needed in the art.

### SUMMARY

Methods, user equipment, computer programs and computer program products for cell selection based on cell congestion levels are disclosed. The use of access control procedures to determine cell congestion levels for a plurality of cells is also disclosed.

In one embodiment, a method for wireless communication by a user equipment is provided. The method comprises acquiring a cell congestion level for each cell from a set of one or more cells of a first radio technology. The first radio technology is an access control radio technology and the cell congestion levels are obtained based on an access control mechanism associated with the respective cell. The method also comprises using the obtained congestion levels to determine whether at least one suitable candidate cell for providing service to the user equipment exists among the plurality of cells of the first radio technology. The method may further comprise, in response to determining that one or more suitable candidate cells for providing service to the user equipment exist, selecting a service cell from the set of one or more cells of the first radio technology for providing service to the user equipment. The method may further comprise, in response to determining that no suitable candidate cell for providing service to the user equipment exists, attempting to find a suitable candidate cell of a radio technology different than the first technology.

In one particular embodiment, determining whether at least one suitable candidate cell for providing service to the user equipment exists among the set of one or more cells of the first technology is based on comparing a congestion level with a threshold congestion level.

In another particular embodiment, the access control parameters comprise an access barring factor and the determination of whether one or more suitable candidate cells exist is based on the access barring factor.

In another particular embodiment, the access control parameters are acquired from signals broadcasted by one or more base stations associated with the one or more cells of the first radio technology.

In a further embodiment, a user equipment is provided. The user equipment comprises circuitry, the circuitry containing instructions which when executed cause the device to perform the method of any of the preceding embodiments. The circuitry may comprise at least one processor and a memory coupled to said processor, the memory containing said instructions.

In a further embodiment, a computer program is provided. The computer program comprising instructions which, when executed on at least one processor, cause the at least one processor to carry out the method according to any of the preceding embodiments. A carrier containing the computer program of is also provided. The carrier may be any one of an electronic signal, an optical signal, a radio signal, or a computer readable storage medium.

In a further embodiment according to the present disclosure, a user equipment comprises means for acquiring a cell congestion level for each cell from a set of one or more cells of a first radio technology, the first radio technology being an access control radio technology, the cell congestion level being obtained based on an access control mechanism associated with the respective cell and means for using (200) the obtained congestion levels to determine whether at least one suitable candidate cell for providing service to the user exists among the plurality of cells of the first radio technology.

In a further embodiment according to the present disclosure, a user equipment comprises a cell congestion acquisition module operative to acquire a cell congestion level for each cell from a set of one or more cells of a first radio technology, the first radio technology being an access control radio technology, the cell congestion level being obtained based on an access control mechanism associated with the respective cell and a suitable candidate cell determination module operative to use the obtained congestion levels to determine whether at least one suitable candidate cell for providing service to the user equipment exists among the plurality of cells of the first radio technology.

Those skilled in the art will appreciate the scope of the present disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a schematic diagram of a mobile network environment where embodiments of the present disclosure can be applied.

FIGS. 2-4 are flow charts illustrating embodiments of methods performed in a user equipment of FIG. 1 for selecting a cell for communication;

FIG. 5 is a schematic diagram of a particular embodiment of the present disclosure;

FIG. 6 is a schematic diagram of another particular embodiment of the present disclosure;

FIG. 7 is a schematic diagram showing some components of an embodiment of a user equipment of FIG. 1;

FIG. 8 is a schematic diagram showing functional modules of the software instructions of the user equipment of FIG. 8 according to one embodiment; and

FIG. 9 shows one example of a computer program product comprising computer readable means.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

As used herein, relational terms, such as “first” and “second,” “top” and “bottom,” and the like, may be used solely to distinguish one entity or element from another entity or element without necessarily requiring or implying any physical or logical relationship or order between such entities or elements. In embodiments described herein, the joining term, “in communication with” and “connected to,” and the like, may be used to indicate electrical or data communication, which may be accomplished by physical contact, induction, electromagnetic radiation, radio signaling, infrared signaling or optical signaling, for example. The above methods of achieving electrical or data communication are non-limiting and mentioned only for illustration. One having ordinary skill in the art will appreciate that multiple components may interoperate and modifications and variations are possible of achieving the electrical and data communication.

In some of the embodiments described below, terminology applicable to 3rd Generation Partnership Project (3GPP) Long Term Evolution (LTE) cellular communication, referred herein as LTE terminology is sometimes used. Note, however, that the embodiments disclosed herein may be applicable to other types of cellular communication.

As used herein, the terms “user device”, “mobile device”, “user equipment (UE)” can be used interchangeably and refer to computing platforms with wireless or wired connectivity, capable of running a wide-ranging variety of applications and services that are either pre-installed by the device manufacturer or are installed/downloaded by the user according to the user's specific usage requirements. The applications themselves may originate from a correspondingly wide-ranging group of software houses, manufacturers and 3rd party developers. Such user devices platforms may include mobile devices such as mobile telephones, ‘smartphones’, personal digital assistants, handheld or laptop computers, tablet computers and similar mobile devices having wireless communications connectivity, or similarly the user devices referred to herein could include fixed devices that are relatively immovable in normal use, such fixed devices having wireless connectivity to enable them to communicate using the wireless communications system. The user devices platforms may also include other device types comprising embedded communications connectivity, such as household appliances, utility meters and security and surveillance equipment, or consumer electronics devices such as still or video cameras, audio/visual entertainment equipment and gaming platforms.

In the present disclosure, the terms “radio access node”, “Evolved or Enhanced Node B (eNB)”, “base station”, “relay station”, “Remote Radio Unit (RRU)” can also be used interchangeably and refer to network nodes operable to provide radio access to user devices.

In the present disclosure, the term “bearer” may be replaced with the terms “connection”, in an LTE context or similar contexts. Such “bearers” or “connections” can be categorized by their information transfer characteristics, methods of accessing the service, inter-working requirements (to other networks) and other general attributes. Information characteristics include data transfer rate, direction(s) of data flow, type of data transfer (circuit or packet) and other physical characteristics. The access methods determine what parts of the system control could be affected by the bearer service. Some bearers must cross different types of networks (e.g. wireless and wired) and the data and control information may need to be adjusted depending on the type of network. Other general attributes might specify a minimum quality level for the service or special conditional procedures such as automatic re-establishment of a bearer after the service has been disconnected due to interference. Some categories of bearer available via the telephone system include synchronous and asynchronous data, packet data and alternate speech and data, video, multimedia, etc. However, while the term “service” is understood in some LTE standard specification, or other similar specifications” to be equivalent to the term “bearer” (or “bearer service”), in the present disclosure the term “service” is to be understood in broader sense, such as from a user point of view, or from an application layer point of view. Some examples are starting a video game, watching a video, using Voice over LTE. Such “services” may translate (e.g. at layers lowers than an application layer) into one or more bidirectional radio and transport bearers. In this context, processing a new service request may trigger bearer setup procedures and/or bearer modification procedures. A bearer modification could be, for example, to lower the resources required or to increase the resources or to add or remove micro-flows.

Access Control

Access control is used in certain radio technologies, such as existent 3GPP LTE, to limit the number of UEs that can access the network.

For example, in 3GPP LTE, the access control mechanism uses a barring factor. Based on the barring factor, some UEs which are rejected by the network must wait and retry again on the same network when there is another opportunity.

In particular, as per 3GPP TS 22.011 (Service accessibility), all UEs are members of one out of ten randomly allocated mobile populations, defined as Access Classes (AC) 0 to 9. The population number is stored in the SIM/USIM. In addition, UEs may be members of one or more out of 5 special categories (Access Classes 11 to 15), also held in the SIM/USIM. These are allocated to specific high priority users.

In case of an overload situation like emergency or congestion, the network may want to reduce the access overload in the cell. To reduce the access from the UE, the network modifies the SIB2 (SystemInformationBlockType2) that contains access barring related parameters.

For regular users with AC 0-9, their access is controlled by ac-BarringFactor and ac-BarringTime. The UE generates a random number—“Rand” generated by the UE has to pass the “persistent” test in order for the UE to access. By setting ac-BarringFactor to a lower value, the access from regular user is restricted (UE must generate a “rand” that is lower than the threshold in order to access) while priority users with AC 11-15 can access without any restriction.

Another type of Access Control is the Service Specific Access Control (SSAC). SSAC is generally used to apply independent access control for telephony services (MMTEL) for mobile originating session requests from idle-mode. Service Specific Access Control (SSAC) allowing IMS voice and video phone calls to be controlled separately from other traffic. SSAC related barring parameters are:
BarringFactorForMMTEL-Voice: barring rate for MMTEL voice
BarringTimeForMMTEL-Voice: barring timer for MMTEL voice
BarringFactorForMMTEL-Video: barring rate for MMTEL video
BarringTimeForMMTEL-Video: barring timer for MMTEL video
   Access control (outside of above conditions)
      As for the ac-barring factor and ac-barring timer, a UE can get the SSAC related parameters from the network.

Regardless of radio technology, currently, access control is used by a UE only with respect to only one cell within a mobile network and decisions based on access control parameters are made based on the level of congestion of this one cell, without consideration of distribution of services among other available cells.

In the following, a number of exemplary embodiments will be presented. It should be noted that these embodiments are not mutually exclusive. Components from one embodiment may be tacitly assumed to be present in another embodiment and it will be obvious to a person skilled in the art how those components may be used in the other exemplary embodiments.

As noted above, distributing the services of a UE to different cells and/or different technologies, based on the cell congestion levels as well as other factors, would be beneficial.

Some embodiments of the present disclosure pertain to a UE to making use of existing access control broadcasted information in a set of cells of a first radio technology to obtain congestion levels of these cells. Based on the obtained congestion levels, the UE decides whether suitable candidates for providing one or more services to the UE exist among these cells. The first radio technology may be 3GPP LTE. From any suitable candidates found, the UE selects some cells for providing the one or more services. The selected cells may be deemed as “best” cells based on assessment of established criteria, e.g. a “best” cell may be the least congested cell. When all cells in the set of cells of the first radio technology have reached a preconfigured level of congestion according to the access control broadcasted information, suitability for providing the one or more services of cells of a second radio technology different than the first radio technology may be considered by the UE.

An important advantage of some of the embodiments of the present disclosure is the increase in the amount of bandwidth available to the UE, as the available bandwidth on different cells and, optionally, on different radio technologies is used.

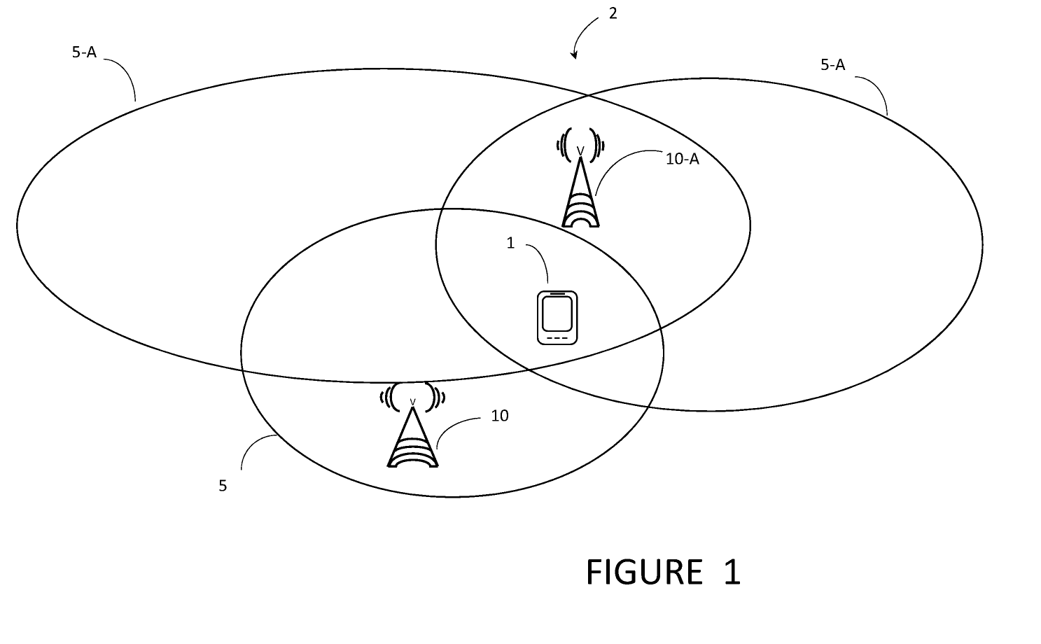

FIG. 1 is a schematic diagram of a mobile network environment where embodiments presented herein can be applied. A user equipment (UE) 1 in a mobile communication network 2, can detect and possibly connect to the mobile network 2 via a plurality of cells 5. Each cell 5 has an associated base station 10, although a base station 10 may have associated one or more cells 5, depending on the radio technology it employs. The plurality of cells 5 comprises one or more cells 5-A based on a radio technology using access control parameters based on which cell congestion levels can be derived, such as 3GPP LTE. A base station associated with a cell 5-A is respectively denoted 10-A. A radio technology using access control parameters based on which cell congestion levels can be derived is referred herein as an access control radio technology. Examples of such technologies are LTE, WCDMA, GSM. Optionally, the plurality of cells 5 comprises one or more cells based on one or more radio technologies not using access control parameters based on which cell congestion levels can be derived, such as WiFi. A radio technology in which cell congestion levels cannot be derived based on access control parameters is referred herein as non-access control radio technology. An example of a non-access control radio technology is WiFi. The plurality of cells 5 may be based on any other current or future radio technology, as long as the principles described hereinafter are applicable.

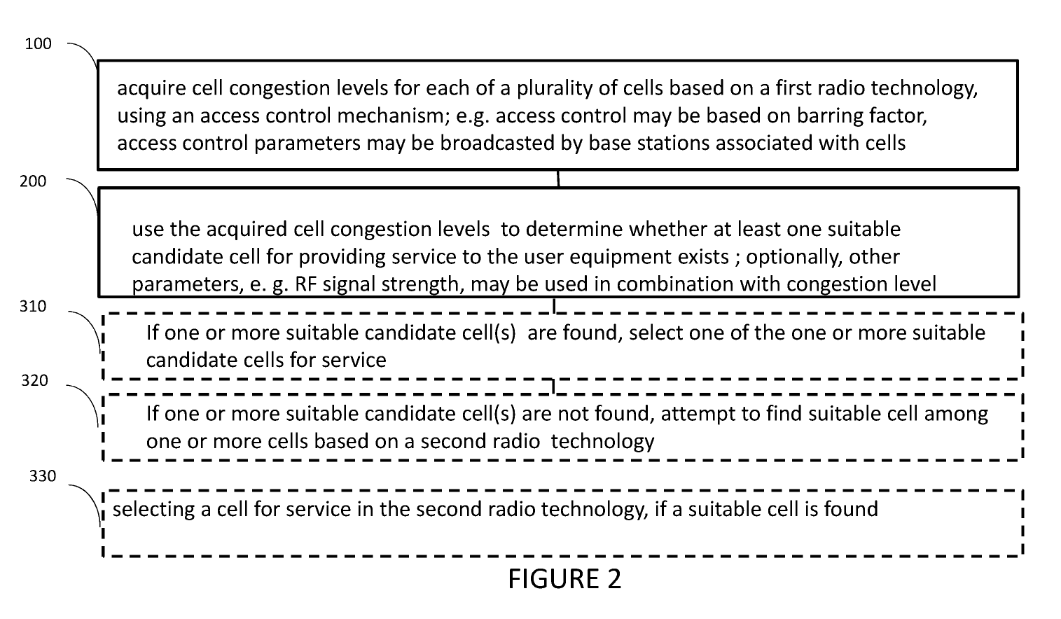

Referring to FIG. 2, in one embodiment, a method for wireless communication by a UE 1 according to an embodiment of the disclosure is illustrated. The method comprises acquiring (100) a cell congestion level for each cell from one or more cells (5-A) based on a first access control radio technology. The cell congestion levels are obtained based on a set of access control parameters associated with the respective cells 5-A. The method also comprises using (200) the acquired congestion levels to determine whether at least one suitable candidate cell for providing service to the user equipment exists among the one or more of cells of the first radio technology. The actual determination of whether suitable candidates exist may be performed at the UE 1 or at another network node, such as a base station, a centralized node etc. For example, the UE may compare itself the acquired congestion levels against a threshold congestion level or it may prepare and send a list of the acquired congestion levels to another network node, for processing. For example, in an LTE or LTE-like environment, the UE 1 may report acquired congestion levels by filling load based barring information in MeasResults Information Element (IE) for each cell 5-A and send this information to eNB(s) in an RRC Measurement Report.

The access control parameters may be received from the base station(s) associated with the one or more cells 5-A, or from one or more other network nodes. The access control parameters may, for example, be broadcasted by the base station(s) within signals that the UE is capable of interpreting, such as LTE's System Identification Block Type 2 (SIB2) messages. The access control parameters may be obtained by UE 1 in one of the following ways:
(a) they may be received from the base station(s) associated with the one or more cells 5-A when an initial connection of the UE with the base stations(s) is established;
(b) they may be periodically retrieved and updated from messages broadcasted by the base station(s) associated with the one or more cells 5-A; in such case, updated versions of the parameters would be available at the UE 1;
c) they may be retrieved at the first opportunity for retrieval from messages broadcasted by the base station(s) associated with the one or more cells 5-A after a new service request is received by the UE 1.

Some examples of access control parameters include a “barring factor” and a “barring time”, such as described in LTE specifications. Thus, for example, in an LTE environment, in step 100 the UE may read load based baring factor information from System Information Block-2 (SIB2) signals from different LTE cells.

Access control parameters may be service specific. As noted above, in LTE, via SSAC, available resources for MMTel video, MMTel Voice, Mobile Initiated data and Mobile Initiated signal can be obtained via associated barring factors.

The method comprises the optional step of, in response to determining that one or more suitable candidate cells for providing service to the user equipment exists, selecting (310-A) a cell from the set of one or more cells of the first radio technology, for providing service to the UE. Alternately, the cell selection can be performed at a network node other than the UE and the UE 1 may be notified by the selection. For example, in an LTE environment, when the UE has reported the acquired congestion levels for cells 5-A to an eNB as load barring information, based on reported load barring information of each cell 5-A, the eNB may chooses a suitable target cell to handover to for a particular service.

The method comprises the optional step of, in response to determining that no suitable candidate cell for providing service to the user equipment exists, attempting (320) to find a suitable candidate cell among one or more cells based on a second radio technology different than the first technology. The second radio technology may be another access control radio technology or a non-access control radio technology. The step of attempting (320) to find a suitable candidate cell of a second technology different than the first radio technology may be followed by selecting (330) a cell for service in the second radio technology, if a suitable cell is found. If the second radio technology is an access control technology, the selection may be based on congestion levels. If the second radio technology is a non-access radio technology the selection may be based on suitability of technology for particular services, for example, best effort video on a WiFi cell.

Determining (200) whether at least one suitable candidate cell for providing service to the user equipment exists among the set of one or more cells of the first technology may be based on comparing a congestion level with a threshold congestion level. The threshold congestion level may be preconfigured, obtained from a source external to the UE or calculated based on other parameters made available to the UE.

In a further embodiment, a “best” cell may be found among suitable candidate cells, based on established criteria. The “best” cell, may, for example, be the least congested cell. The assessment may be with respect to a specific service, when access control parameters that are service specific are available: for example, if UE 1 is searching for suitable candidates for service A (e.g. one of voice, video, data, etc.), out of a plurality of services, the least congested cell out for service A can be deemed to be the “best” cell, in this scenario.

In one embodiment, selecting (310) a cell for service may be based on a combination of cell RF signal strength and congestion level.

In one embodiment, selecting (310) a cell for service may be based on any combination of other criteria, in addition to the congestion level of the suitable candidate cells. Such additional criteria may be:
RF strength measured for some or all of the suitable candidate cells;
Signal to Noise Ratio (SINR) measured for some or all of the suitable candidate cells;
Indication that certain services are known to work well in certain technologies. For example, best effort video is known to work well in a WiFi cell, thus, if WiFi cells exist among cells 5 and best effort video is one of the services the UE 1 needs, then WiFi cells may be considered more suitable for service than other cells;

The assignment, configuration and release of connections and radio resources between a UE and a radio access node can be established via various protocols. For example, in LTE, the assignment, configuration and release of connections and radio resources between a UE and a radio access node can be established via various protocols, such as the Radio Resource Control (RRC) protocol. An example of an RRC protocol is described in detail in the 3GPP TS 36.331 v12.1.0 (2014-03) technical specification. There are the two basic RRC connection modes for a UE: “idle mode” (or RRC_IDLE), and “connected mode” (or RRC_CONNECTED). Furthermore, an example of access control procedure defined for idle mode (IM) UE's is given in 3GPP TS 36.331 v12.1.0 (2014-03) specification. According to this access control procedure, whenever a service is requested by a UE in RRC_IDLE, the UE reads a set of access control parameters broadcasted by radio access nodes within the network and applies the access control procedures as prescribed. Through this access control procedure, user devices in idle mode attempting to gain access to a network may be barred from using network resources so that other devices can be allowed access to prevent congestion and to control access to limited network resources.

If a cell of a non-access control technology is selected for service, after step 330, the service maintenance or initiation may be based on suitability of a radio technology for a specific service. For example, best effort video can be mapped to WiFi and voice can be mapped to CDMA. A map of preferred (suitable) services with respect to radio technologies may be available at UE (either pre-configured or obtained from an external source) for use in selecting a cell of a certain non-access control radio technology based on service suitability.

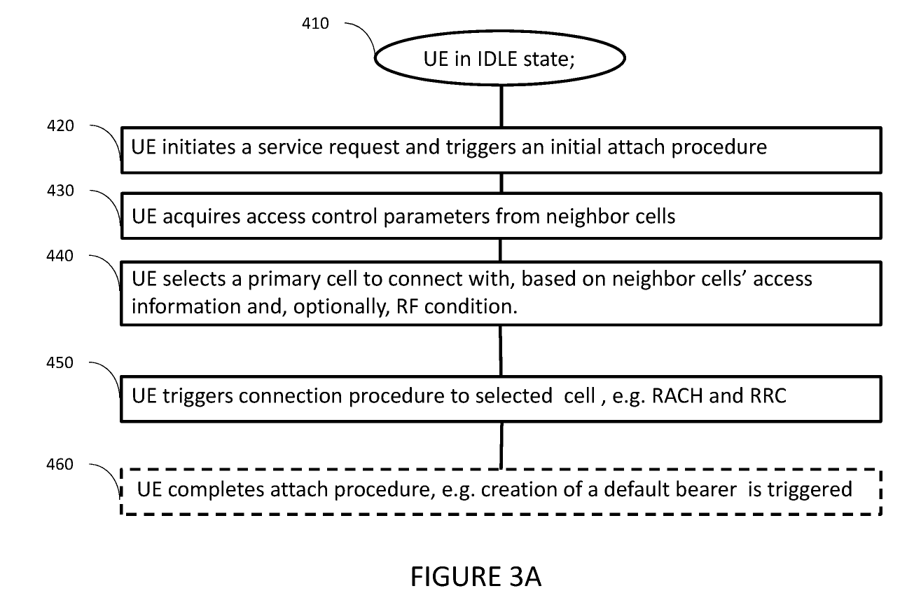

FIG. 3A illustrates a flow chart for a method for a UE according to one embodiment of the present disclosure. The UE is establishing a service in a cell based on an access control technology, starting from an IDLE state.
410. UE in IDLE state;
420. The UE initiates a service request and triggers an initial attach procedure; the service request may come, for example, from the application layer or from another layer. For example, creating a Voice over Internet Protocol (VoIP) bearer requires the VoIP client to trigger the lower RRC layer to initiate the Service Request.
430. The UE acquires access control parameters, such as barring information in LTE, from cells 5-A. The access control parameters are broadcasted over the network via messages, such as LTE's SIB2 messages. The access control information may be specific to the type of requested service (e.g. voice, video, data, etc.)
440. The UE selects a primary cell to connect with, based on cells' congestion level, such as derived from a barring factor in LTE, for the service type and RF condition.
450. The UE triggers connection setup procedures such as via the LTE random-access channel (RACH) and RRC connection setup procedures, with the selected primary cell.
460. Optionally, the UE triggers also completion of an attach procedure. For example, in LTE, the UE triggers a default bearer to be created.

FIG. 3B illustrates a flow chart for a method for a UE according to one embodiment of the present disclosure, analogous to the method of FIG. 3A. However, while FIG. 3A illustrates a UE initiated method, FIG. 3B illustrates a network initiated method. Like in FIG. 3A, the UE starts also in an IDLE state (410). In step 415, the network node pages the UE. The page from the network wakes up UE 1 (for example, from Discontinuous Reception (DRX)). The remaining steps in FIG. 3B are the same as in FIG. 3A.

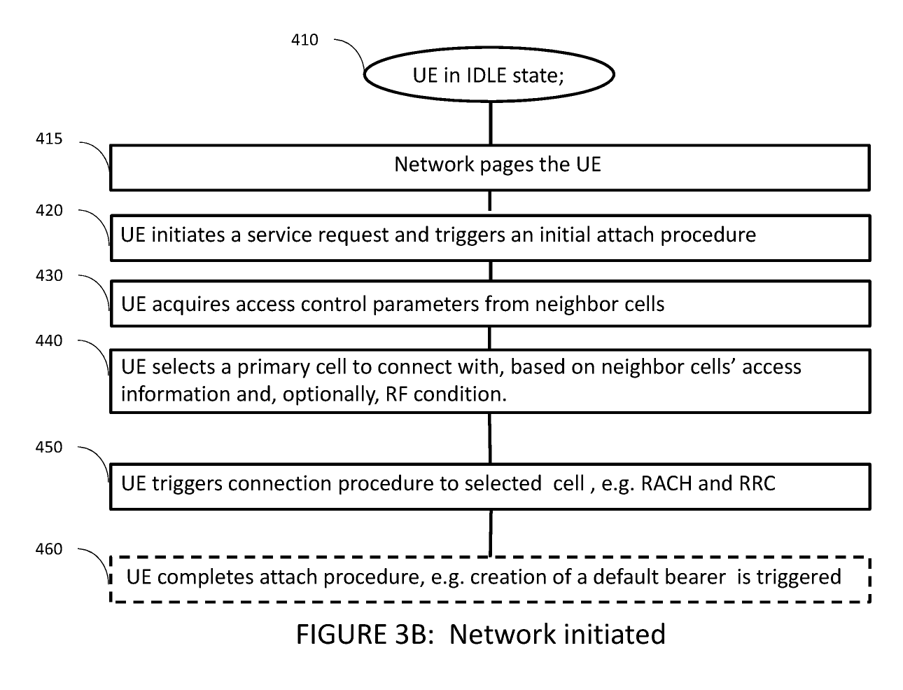

FIG. 4 illustrates a flow chart for a method for a UE according to one embodiment of the present disclosure. The UE is in a carrier aggregation environment and is establishing a service in a cell based on an access control technology, starting from a CONNECTED state.
510. UE is in CONNECTED state, for an existent service.
520. The UE receives a request for a new service. The new service request may come, for example, from the application layer or from another layer.
530. The UE acquires access control information from all LTE neighbor cells by reading the SIBs from the LTE cells; In LTE, the access control information may comprise access barring information; the access control information may be specific to the type of the new requested service (e.g. voice, video, etc.).;
540. The UE selects a cell for new service, based at least on the acquired access control information; optionally, the selection of the cell is also based on an RF condition indicator of the cell and/or other parameters. For example, the RF signal strength for neighboring cells can be monitored by reading the reference signals. The cell can be the one meeting a desired combination of congestion level and RF signal strength.
550. The UE determines whether the selected cell is a primary cell? If YES, step 560 is performed. If NO: The UE sets up a connection to the selected cell via the primary cell; Once the connection is set up, the selected cell is ready to provide service and step 560 is performed.
560. The UE triggers a service setup on the selected cell. For example, in LTE, the UE may trigger the Mobility Management Entity (MME) to setup a bear with the selected cell.

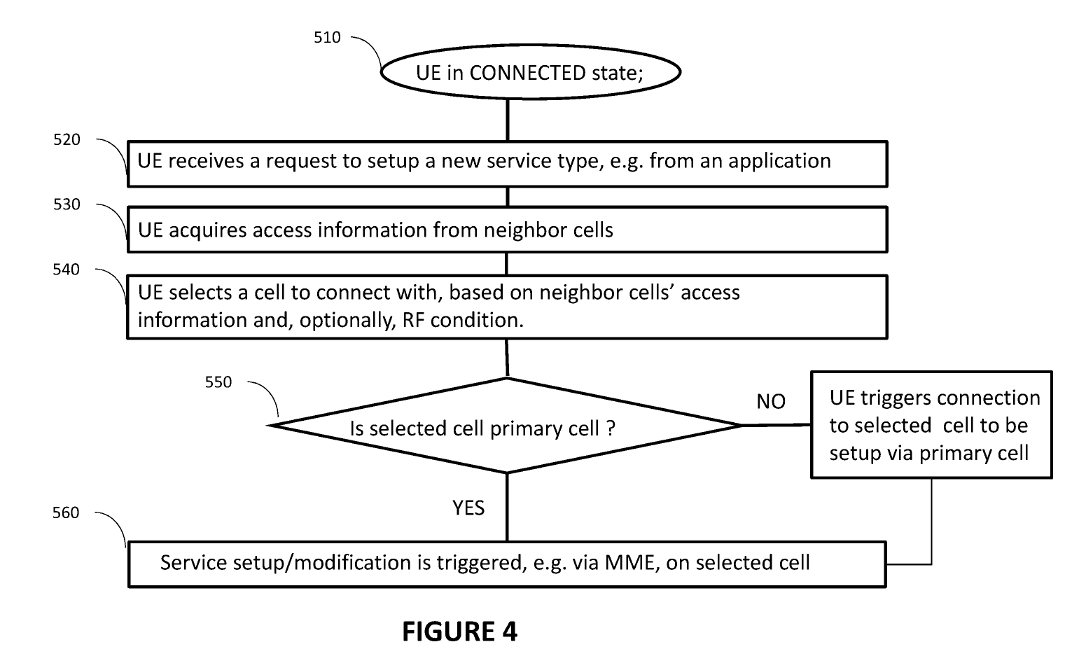

FIG. 5 is a schematic diagram of a particular embodiment of the present disclosure. In this embodiment, UE 1 acquires service specific available resources for each of a plurality of LTE cells 5-A, by acquiring access control parameters, from which service specific resources (e.g. resources for services such as MMTel voice, MMTel video, Mobile initiated data, Mobile initiated signal) can be derived. The UE 1 also acquires the RF strength for each cell of interest. Based on the combined information of RF strength and service specific available resources, the UE triggers the distribution of various services in various cells. For example, for a set of neighbor cells, the UE 1 acquires the following information:

| | | Available resources for specific |
|---|---|---|
| Neighbor cell | RF Strength | services |
| Primary LTE cell 1 | Medium | MMTel voice = 35% |
| | | MMTel video = 30% |
| | | Mobile Initiated data = 70% |
| | | Mobile Initiated signal = 75% |
| Secondary LTE cell 2 | High | MMTel voice = 85% |
| | | MMTel video = 70% |
| | | Mobile Initiated data = 30% |
| | | Mobile Initiated signal = 25% |
| Secondary LTE cell 3 | Medium | MMTel voice = 55% |
| | | MMTel video = 80% |
| | | Mobile Initiated data = 60% |
| | | Mobile Initiated signal = 55% |
| Other cells | Low | |

Based on the acquired information, UE 1 triggers mobile initiated video services in LTE cell 1, an MMTel voice call (e.g. VoLTE) in cell 2 and an MMTel video session in LTE cell 3. In this scenario, the acceptable RF strength required is “medium” and the cell for which the RF signal strength is low is not considered for service. Thus, in these exemplary embodiments, the UE 1 may trigger the distribution of services (e.g. setup of sessions for the services) on more cells, based on suitability of each of the cells for a specific service. The suitability of cells for specific services is determined based on service specific access parameters which the UE 1 acquires from the network.

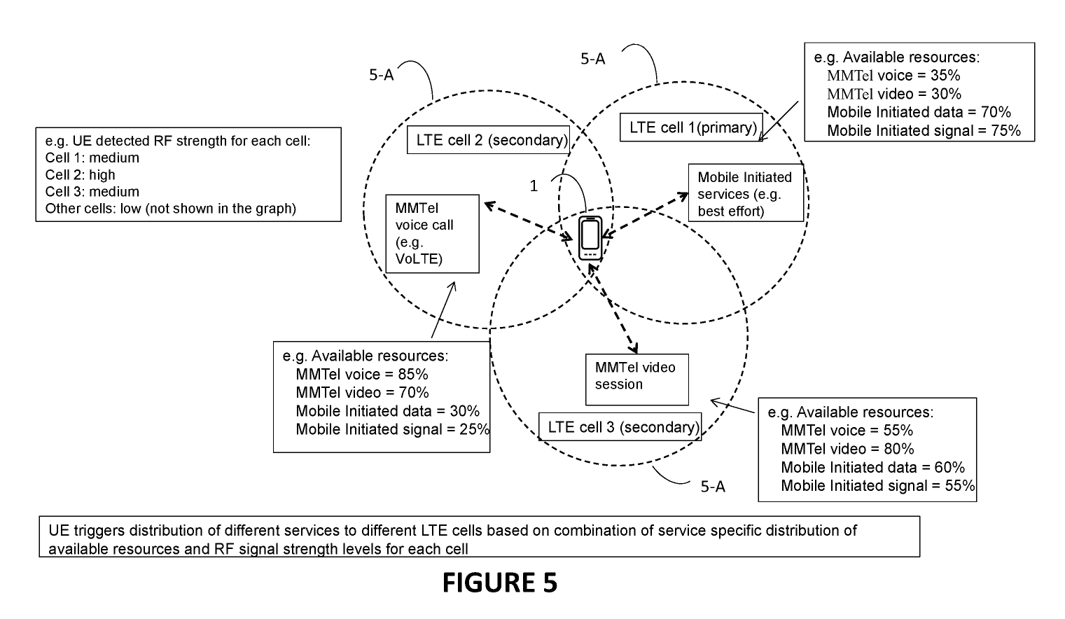

FIG. 6 is a schematic diagram of another particular embodiment of the present disclosure. In this embodiment, UE 1 acquires congestion levels for a plurality of cells 5 based on different radio technologies. For example, for a bearer that requires high bandwidth, UE 1 acquires the barring factors from the LTE cells. If all LTE cells have barring factors that exceed a threshold, then UE1 selects a WiFi cell for the bearer.

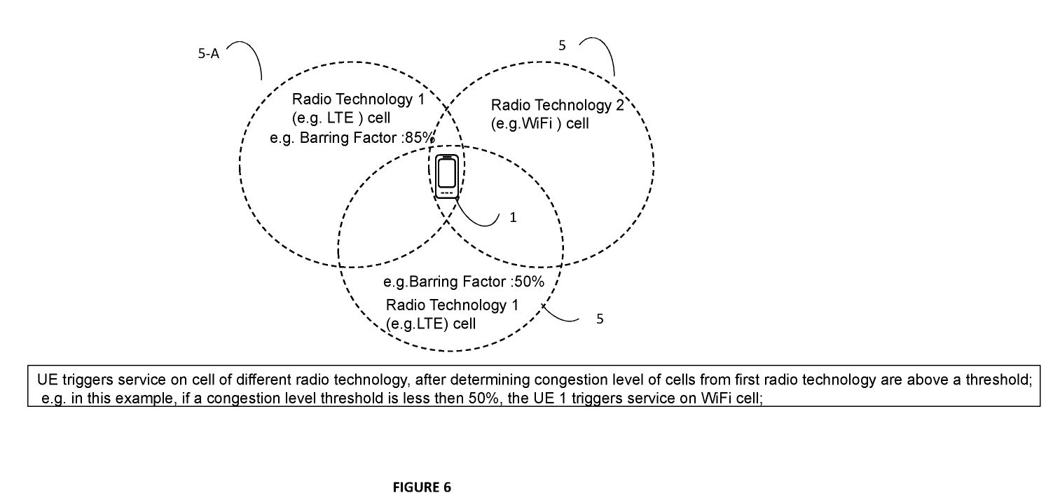

FIG. 7 is a schematic diagram showing some components of a UE 1 in FIG. 1. It is to be noted that the UE does not need to be (but can be) implemented as one device and can be distributed over several devices connected locally or remotely.

A processor 60 is provided using any combination of one or more of a suitable central processing unit (CPU), multiprocessor, microcontroller, digital signal processor (DSP), application specific integrated circuit (ASIC) etc., capable of executing software instructions 66 stored in a memory 64, which can thus be a computer program product. The processor 60 can be configured to execute the methods described with reference to FIGS. 2-4 above.

The memory 64 can be any combination of read and write memory (RAM) and read only memory (ROM). The memory 64 also comprises persistent storage, which, for example, can be any single one or combination of magnetic memory, optical memory, solid state memory or even remotely mounted memory.

A data memory 65 can be any combination of read and write memory (RAM) and read only memory (ROM). The data memory 65 may also comprise persistent storage, which, for example, can be any single one or combination of magnetic memory, optical memory, solid state memory or even remotely mounted memory.

The data memory 65 can e.g. store access control parameters 67 received from the network to be used for cell selection as described above.

The UE 1 further comprises an I/O interface 62 for communicating with a user and optionally with (other) user equipment devices.

The UE 1 also comprise one or more transceivers 61, comprising analogue and digital components for radio communication with base stations or other network nodes.

Other components of the UE 1 are omitted in order not to obscure the concepts presented herein.

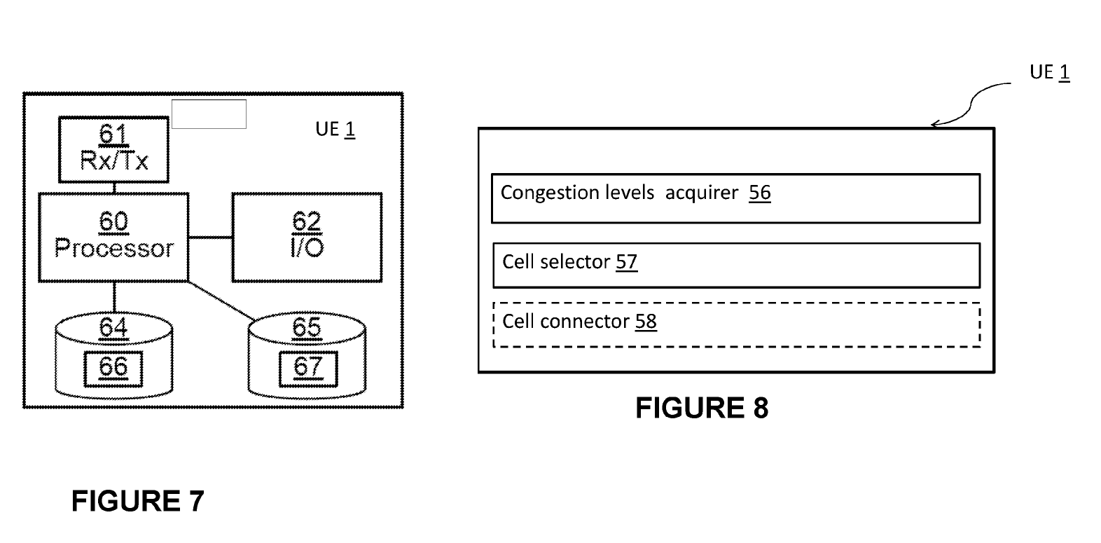

FIG. 8 is a schematic diagram showing functional modules of the software instructions 66 of the UE 1, of FIG. 7 according to one embodiment. The modules are implemented using software instructions such as a computer program executing in the network node. The modules correspond to the steps in the methods illustrated in FIGS. 2-4. A congestion level acquirer 56 corresponds to steps 100, 430 and 530. A cell selector 58 corresponds to steps 200, 440, 540 and, it may further correspond to optional steps 310, 320 and 330. An optional cell connector 58 corresponds to steps for connecting to a cell, after a suitable cell is selected, such as steps 450 and 550.

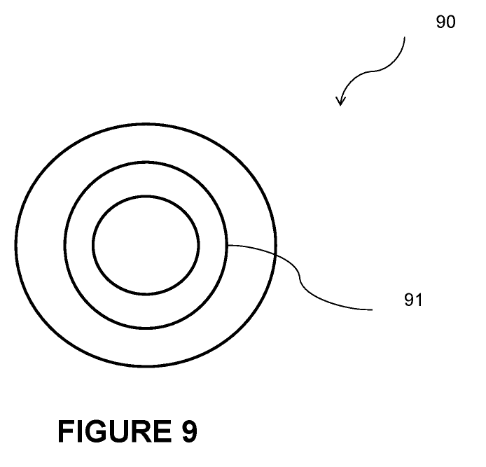

FIG. 9 shows one example of a computer program product 90 comprising computer readable means. On this computer readable means a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 66 of FIG. 6. While the computer program 91 is here schematically shown as a track on the depicted optical disk, the computer program can be stored in any way which is suitable for the computer program product, such as a removable solid state memory, e.g. a Universal Serial Bus (USB) drive.

Many embodiments described herein describe steps being performed by a User Equipment 1. However, it will be recognized that many such steps (e.g. acquisition of congestion levels based on access parameters, determination of suitable candidate cell, selection of cell) can be performed by another node in a wireless network. Furthermore, the operation can be distributed over a plurality of physical nodes. Thus, in the described embodiments, the term user equipment can be understood, generally, as a network entity, or network node, or a collection of network nodes.

### Abbreviations

### CDMA Code-Division Multiple Access

### eNB E-UTRAN Node B

### E-UTRAN Evolved Universal Terrestrial Radio Access Network

GSM Global System for Mobile communications

### LTE Long Term Evolution

### MME Mobility Management Entity

MMTel Multimedia Telephony service

### RACH Random Access Channel

### RF Radio Frequency

### RRC Radio Resource Control

### SIB2 System Information Block Type 2

### SSAC Service Specific Access Control

### UE User Equipment

### WCDMA Wideband Code-Division Multiple Access

### WiMAX Worldwide Interoperability for Microwave Access

### 3GPP 3rd Generation Partnership Project

Those skilled in the art will recognize improvements and modifications to the embodiments of the present disclosure. All such improvements and modifications are considered within the scope of the concepts disclosed herein and the claims that follow.

### Enumerated Embodiments

In the following a number of non-limiting embodiments will be presented, enumerated with roman numerals.

i. A method for wireless communication by a user equipment, comprising:

acquiring a cell congestion level for each cell from one or more cells of a first radio technology, the first radio technology being an access control radio technology, the cell congestion levels being acquired based on an access control parameters; and

using the acquired congestion levels to determine whether at least one suitable candidate cell for providing service to the user equipment exists among the one or more cells of the first radio technology.

ii. The method of embodiment i further comprising, in response to determining that one or more suitable candidate cells for providing service to the user equipment exists, selecting a cell from the set of one or more cells of the first radio technology for providing service to the user equipment.
iii. The method of embodiment i further comprising, in response to determining that no suitable candidate cell for providing service to the user equipment exists, attempting to find a suitable candidate cell among one or more cells based on a second radio technology different than the first technology.
iv. The method of embodiment i, wherein determining whether at least one suitable candidate cell for providing service to the user equipment exists among the one or more cells of the first technology is based on comparing a congestion level with a threshold congestion level.
v. The method of embodiment i, wherein the access control parameters comprise an access barring factor.
vi. The method of embodiment i, wherein the access control parameters are acquired from signals broadcasted by one or more base stations associated with the one or more cells of the first radio technology.
vii. A user equipment comprising circuitry, the circuitry containing instructions which when executed cause the user equipment to:

acquire a cell congestion level for each cell from one or more cells of a first radio technology, the first radio technology being an access control radio technology, the cell congestion levels being acquired based on an access control parameters; and

use the acquired congestion levels to determine whether at least one suitable candidate cell for providing service to the user equipment exists among the one or more cells of the first radio technology.

viii. The user equipment of embodiment vii, the circuitry further comprising instructions which when executed cause the user equipment to, in response to determining that one or more suitable candidate cells for providing service to the user equipment exists, select a cell from the one or more cells of the first radio technology for providing service to the user equipment.
ix. The user equipment of embodiment vii, the circuitry further comprising instructions which when executed cause the user equipment to, in response to determining that no suitable candidate cell for providing service to the user equipment exists, attempt to find a suitable candidate cell of a radio technology different than the first technology.
x. The user equipment of embodiment vii, wherein the access control parameters comprise an access barring factor and the determination of whether one or more suitable candidate cells exist is based on the access barring factor.
xi. The user equipment of any of embodiments vii-x, wherein said circuitry comprises at least one processor and memory coupled to said processor, said memory comprising said instructions.
xii. A computer program comprising instructions which, when executed on at least one processor, cause the at least one processor to carry out the method according to any one of embodiments i-vi.
xiii. A carrier containing the computer program of embodiment xii, wherein the carrier is one of an electronic signal, an optical signal, a radio signal, or a computer readable storage medium.
xiv. A user equipment in a cellular communications network, comprising:

means for acquiring a cell congestion level for each cell from one or more cells of a first radio technology, the first radio technology being an access control radio technology, the cell congestion levels being acquired based on an access control parameters; and

means for using the obtained congestion levels to determine whether at least one suitable candidate cell for providing service to the user equipment exists among the one or more cells of the first radio technology.

xv. A user equipment comprising:

a congestion level acquirer operative to acquire a cell congestion level for each cell from one or more cells of a first radio technology, the first radio technology being an access control radio technology, the cell congestion levels being acquired based on an access control parameters; and

a cell selector operative to use the obtained congestion levels to determine whether at least one suitable candidate cell for providing service to the user equipment exists among the one or more cells) of the first radio technology.

The above description is provided to enable persons skilled in the art to implement the various embodiments described and illustrated. The described methods and apparatuses are presented for purpose of illustration and not of limitation. It should be understood that various changes, substitutions and alterations can be made and still fall within the broad scope of the present methods and apparatuses described in this specification. For example, many of the features and functions discussed above can be implemented in software, hardware, or firmware, or a combination thereof. Also, many alternatives, variations, and modifications will be apparent to those of ordinary skill in the art. Other such alternatives, variations, and modifications are intended to fall within the scope of the following appended claims.

1. A method for wireless communication by a user equipment, comprising:
acquiring a cell congestion level for each cell from one or more cells of a first radio technology, the first radio technology being an access control radio technology, the cell congestion levels being acquired based on an access control parameters; and
using the acquired congestion levels to determine whether at least one suitable candidate cell for providing service to the user equipment exists among the one or more cells of the first radio technology.

2. The method of claim 1 further comprising, in response to determining that one or more suitable candidate cells for providing service to the user equipment exists, selecting a cell from the set of one or more cells of the first radio technology for providing service to the user equipment.

3. The method of claim 1 further comprising, in response to determining that no suitable candidate cell for providing service to the user equipment exists, attempting to find a suitable candidate cell among one or more cells based on a second radio technology different than the first technology.

4. The method of claim 1, wherein determining whether at least one suitable candidate cell for providing service to the user equipment exists among the one or more cells of the first technology is based on comparing a congestion level with a threshold congestion level.

5. The method of claim 1 wherein the access control parameters comprise an access barring factor.

6. The method of claim 1 wherein the access control parameters are acquired from signals broadcasted by one or more base stations associated with the one or more cells of the first radio technology.

7. A user equipment comprising circuitry, the circuitry containing instructions which when executed cause the user equipment to:
acquire a cell congestion level for each cell from one or more cells of a first radio technology, the first radio technology being an access control radio technology, the cell congestion levels being acquired based on an access control parameters; and
use the acquired congestion levels to determine whether at least one suitable candidate cell for providing service to the user equipment exists among the one or more cells of the first radio technology.

8. The user equipment of claim 7, the circuitry further comprising instructions which when executed cause the user equipment to, in response to determining that one or more suitable candidate cells for providing service to the user equipment exists, select a cell from the one or more cells of the first radio technology for providing service to the user equipment.

9. The user equipment of claim 7, the circuitry further comprising instructions which when executed cause the user equipment to, in response to determining that no suitable candidate cell for providing service to the user equipment exists, attempt to find a suitable candidate cell of a radio technology different than the first technology.

10. The user equipment of claim 7, wherein the access control parameters comprise an access barring factor and the determination of whether one or more suitable candidate cells exist is based on the access barring factor.

11. The user equipment of claim 7, wherein said circuitry comprises at least one processor and memory coupled to said processor, said memory comprising said instructions.

12-13. (canceled)

14. A user equipment in a cellular communications network, comprising:
means for acquiring a cell congestion level for each cell from one or more cells of a first radio technology, the first radio technology being an access control radio technology, the cell congestion levels being acquired based on an access control parameters; and
means for using the obtained congestion levels to determine whether at least one suitable candidate cell for providing service to the user equipment exists among the one or more cells of the first radio technology.

15. A user equipment comprising:
a congestion level acquirer operative to acquire a cell congestion level for each cell from one or more cells of a first radio technology, the first radio technology being an access control radio technology, the cell congestion levels being acquired based on an access control parameters; and
a cell selector operative to use the obtained congestion levels to determine whether at least one suitable candidate cell for providing service to the user equipment exists among the one or more cells of the first radio technology.
